(19) United States
(12) Patent Application Publication
(10) Pub. No.: US 2017/0093209 A1
(43) Pub. Date: Mar. 30, 2017

(54) METHOD FOR CONTROLLING OUTPUT VOLTAGE OF DIRECT CURRENT POWER SUPPLY DEVICE AND DEVICE FOR CONTROLLING OUTPUT VOLTAGE

(71) Applicant: FUJI ELECTRIC CO., LTD., Kawasaki-shi (JP)

(72) Inventor: Seitaro BANNO, Hino (JP)

(73) Assignee: FUJI ELECTRIC CO., LTD., Kawasaki-shi (JP)

(21) Appl. No.: 15/374,402

(22) Filed: Dec. 9, 2016

Related U.S. Application Data
(63) Continuation of application No. PCT/JP2014/081809, filed on Dec. 2, 2014.

(51) Int. Cl. H02J 9/06; H02M 3/04; H02M 1/42; H02M 7/04

(52) U.S. Cl. CPC H02J 9/061; H02M 7/04; H02M 3/04; H02M 1/42

(57) ABSTRACT

A method and related devices for controlling an output voltage of a direct current power supply device. An output voltage command value of a battery unit is calculated in advance by adding output voltage when a power supply unit acting as a main power supply unit operates and a voltage drop caused by wiring resistance from the battery unit, which acts as a back-up unit, to an output point, whereby, when the back-up operation is carried out, voltage of the output point when the battery unit is operated in accordance with the output voltage command value is equivalent to the voltage of the output point when the power supply unit is operated when an alternating current power supply is sound.

### CROSS-REFERENCE TO RELATED APPLICATIONS

This application is a continuation application, filed under 35 U.S.C. §111(a), of International Application PCT/JP2014/081809 filed on Dec. 2, 2014 the content of which is incorporated herein by reference in its entirety.

### BACKGROUND

1. Field

The present disclosure relates to a method for controlling an output voltage and a device for controlling an output voltage such that, in a direct current power supply device wherein a multiple of direct current power supply units including a back-up unit are connected in parallel to a load, a predetermined direct current voltage can be supplied to the load by compensating for a voltage drop caused by wiring resistance in a power line from the back-up unit to the load.

2. Related Art

Background art described in JP Application Publication 2007-209195 (particularly, paragraphs [0035] to [0037], FIG. 1, FIG. 9) is known as a direct current power supply device formed of a multiple of direct current power supply units connected to each other in parallel.

FIG. 7 is a configuration diagram of the background art, wherein 100 is an alternating current power supply, 200a and 200b are AC/DC converters, 300a and 300b are back-up power supplies, and 400 is a load to which direct current voltage is applied. Herein, the AC/DC converters 200a and 200b and the back-up power supplies 300a and 300b all function as direct current power supply units, and are connected to each other in parallel.

The AC/DC converters 200a and 200b are of the same configuration, the AC/DC converter 200a, for example, including a PFC (power factor correction) circuit 201, a DC/DC converter 202, a semiconductor switching element 203, a control circuit 204, a smoothing capacitor 205, and a current detector 206.

Also, the back-up power supplies 300a and 300b are of the same configuration, the back-up power supply 300a, for example, including a power failure detection circuit 301, a secondary battery 302, a battery monitor 303, a bidirectional DC/DC converter 304, a control circuit 305, a semiconductor switching element 306, a smoothing capacitor 307, and a current detector 308.

200P, 200N, 300P, and 300N are positive and negative output terminals of the AC/DC converters 200a and 200b and back-up power supplies 300a and 300b. The output terminals 200P, 200N, 300P, and 300N are connected in parallel by a power line 501. Also, the AC/DC converters 200a and 200b and back-up power supplies 300a and 300b are connected to each other in parallel via a signal line 502.

250a, 250b, 350a, 350b, 650a, 650b, 750a, and 750b indicate connectors.

FIG. 8 shows an example of a mounting structure of the AC/DC converters 200a and 200b and back-up power supplies 300a and 300b. The AC/DC converters 200a and 200b and back-up power supplies 300a and 300b are mounted by the connectors 250a, 250b, 350a, and 350b being connected to the connectors 650a, 650b, 750a, and 750b respectively on a device main body 800 side.

### SUMMARY

The background art shown in FIG. 7 and FIG. 8 is such that a voltage drop caused by wiring resistance occurs in a path from the output terminals 200P, 200N, 300P, and 300N of the AC/DC converters 200a and 200b and back-up power supplies 300a and 300b via the connectors 650a, 650b, 750a, and 750b and power line 501 to the load 400, and the magnitude of the voltage drop is a value that varies in accordance with wiring length.

Therefore, when the alternating current power supply 100 is sound and the AC/DC converter 200a supplies a predetermined direct current voltage to the load 400, the following kind of problem occurs when the alternating current power supply 100 fails and, for example, the back-up power supply 300a operates as a back-up.

That is, the length of wiring from the connector 650a on the AC/DC converter 200a side to the load 400 and the length of wiring from the connector 750a on the back-up power supply 300a side to the load 400 are different. Therefore, even when operation is carried out with an output voltage command value with respect to the back-up power supply 300a the same as an output voltage command value of the AC/DC converter 200a at a normal time, voltage applied to the load 400 when backing-up differs from voltage applied at a normal time due to the voltage drop caused by the discrepancy in wiring lengths, and an error occurs between the two voltages.

Therefore, when the load 400 is a server or a storage and an input voltage thereto is required with high accuracy or when a low voltage and a large current are output to the load 400, the above-described voltage error is not negligible.

Therefore, this disclosure provides a method for controlling an output voltage of a direct current power supply device and a device for controlling an output voltage such that a predetermined voltage required by a load can be output with high accuracy by calculating an output voltage command value of a back-up direct current power supply unit, taking into consideration a voltage drop caused by wiring resistance.

In order to provide the above described method, a method for controlling an output voltage according to a first aspect of the disclosure relates to a method for controlling an output voltage of a direct current power supply device including a main power supply unit, which supplies direct current voltage obtained by converting alternating current power supply voltage to a load via an output point, and a back-up unit, which supplies direct current voltage to the load via the output point using a back-up operation when operation of the main power supply unit is stopped.

Further, the disclosure is characterized in that an output voltage command value of the back-up unit is calculated by adding voltage of the output point when the main power supply unit operates and a voltage drop caused by wiring resistance from the back-up unit to the output point, whereby voltage of the output point when the back-up unit is operated in accordance with the output voltage command value is equivalent to the voltage of the output point when the main power supply unit operates.

Also, the method for controlling an output voltage according to a second aspect of the disclosure is the method for controlling the output voltage according to the first aspect of the disclosure wherein, as a calibration operation that calculates the output voltage command value of the back-up unit for when a back-up operation is carried out, output voltage of the back-up unit is gradually raised when the main power supply unit operates, wiring resistance from the back-up unit to the output point is calculated using output voltage of the main power supply unit and output voltage and output current of the back-up unit, and the output voltage command value is calculated in advance by adding the product of the wiring resistance and output current to the voltage of the output point.

A device for controlling an output voltage according to a third aspect of this disclosure relates to a direct current power supply device including a main power supply unit, which supplies direct current voltage obtained by converting alternating current power supply voltage to a load via an output point, and a back-up unit, which supplies direct current voltage to the load via the output point using a back-up operation when operation of the main power supply unit is stopped.

Further, the disclosure is characterized in that each of the main power supply unit and back-up unit includes means of detecting output voltage and output current, and the back-up unit includes control means that calculates wiring resistance from the back-up unit to the output point using output voltage of the main power supply unit when the main power supply unit operates and output voltage and output current of the back-up unit, and calculates an output voltage command value of the back-up unit itself in advance by adding the product of the wiring resistance and output current of the back-up unit itself to the voltage of the output point.

A device for controlling an output voltage according to a fourth aspect of the disclosure relates to a direct current power supply device including a main power supply unit, which supplies direct current voltage obtained by converting alternating current power supply voltage to a load via an output point, a back-up unit, which supplies direct current voltage to the load via the output point using a back-up operation when operation of the main power supply unit is stopped, and external management means capable of communication between the main power supply unit and the back-up unit.

Further, the disclosure is characterized in that each of the main power supply unit and back-up unit includes means of detecting output voltage and output current, and the management means includes control means that calculates wiring resistance from the back-up unit to the output point using output voltage of the main power supply unit when the main power supply unit operates and output voltage and output current of the back-up unit, calculates an output voltage command value of the back-up unit in advance by adding the product of the wiring resistance and output current of the back-up unit to the voltage of the output point, and transmits the output voltage command value to the back-up unit.

The disclosure is such that an output voltage command value that compensates for a voltage drop caused by wiring resistance from a back-up unit to an output point of a main power supply unit is calculated in advance, and the back-up unit is operated in accordance with the output voltage command value when a back-up operation is carried out.

Therefore, voltage of the same magnitude as output voltage of the main power supply unit can also be generated at the output point when a back-up operation is carried out, regardless of the position of the back-up unit, whereby voltage required by a load can be supplied with high accuracy and stably.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a configuration diagram showing an embodiment of the disclosure.

FIG. 2 is a configuration diagram of a main portion of each unit in FIG. 1.

FIG. 3 is a configuration diagram of a main portion of each unit in FIG. 1.

FIG. 4 is a perspective view showing a mounting structure of each unit and a load in the embodiment of the disclosure.

FIG. 5 is a perspective view showing a mounting structure of each unit and the load in the embodiment of the disclosure.

FIG. 6 is a flowchart showing a process in each unit when there is a calibration request in the embodiment of the disclosure.

FIG. 7 is a configuration diagram showing background art.

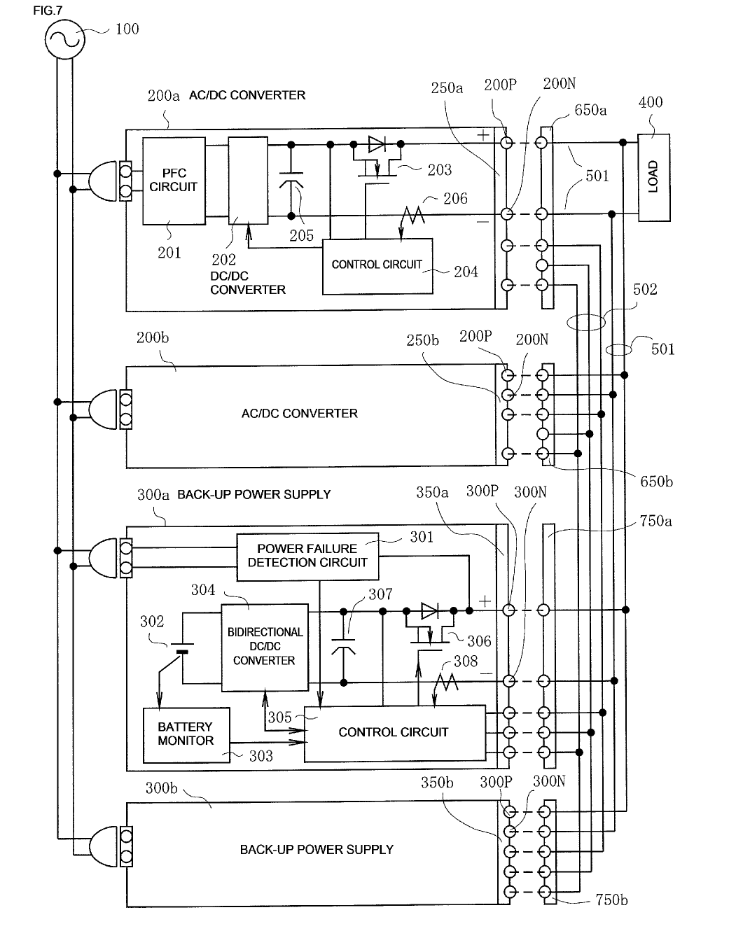

FIG. 8 is a perspective view showing a mounting structure of each unit according to the background art.

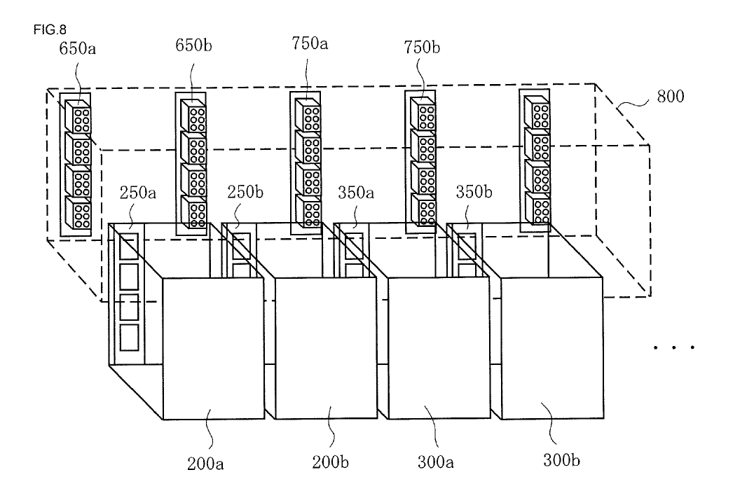

### DESCRIPTION OF EMBODIMENTS

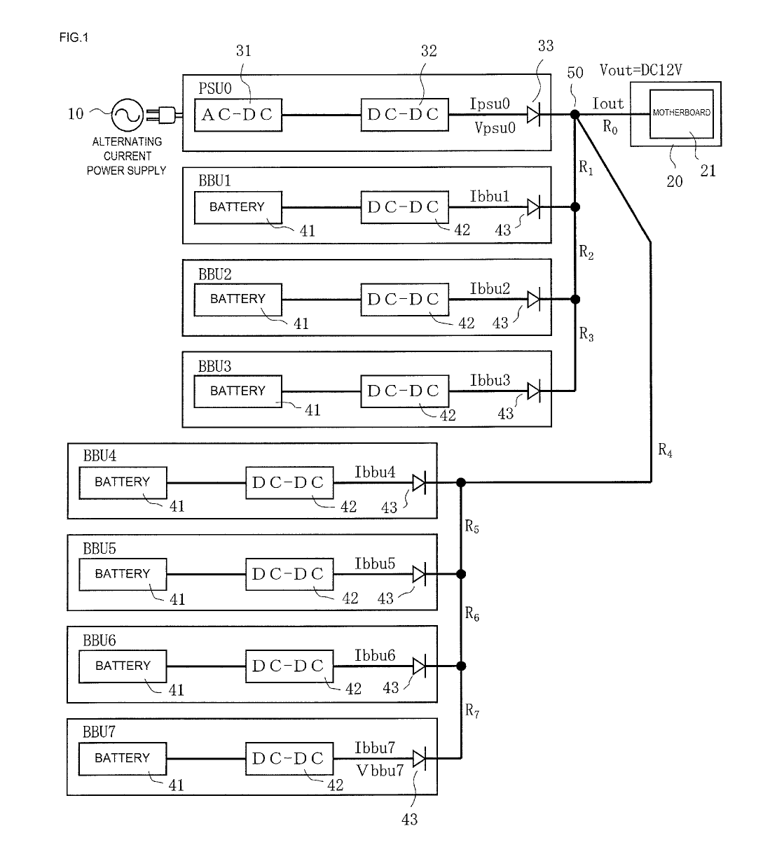

Hereafter, based on the drawings, a description will be given of an embodiment of the disclosure. Firstly, FIG. 1 shows a configuration of the embodiment of the disclosure.

In FIG. 1, a load 20 is connected via a power supply unit PSU0 to an alternating current power supply 10 such as a commercial power supply. Although not particularly limited provided that a direct current voltage is supplied, the load 20 is, for example, a server or a storage in which a motherboard 21 is incorporated.

The power supply unit PSU0 includes an AC/DC conversion unit 31, which is connected to the alternating current power supply 10 and converts alternating current voltage into direct current voltage, a DC/DC conversion unit 32, which is connected to the output side of the AC/DC conversion unit 31 and converts the direct current voltage into direct current voltage of a predetermined magnitude, and a diode 33 connected between the output side of the DC/DC conversion unit 32 and the load 20.

Also, a plurality (seven in the example shown) of battery units BBU1 through BBU7 are connected so that output sides thereof are parallel to that of the power supply unit PSU0. Configurations of the battery units BBU1 through BBU7 are all the same, including a battery 41, a DC/DC conversion unit 42 that converts direct current voltage of the battery 41 into direct current voltage of a predetermined magnitude, and a diode 43 connected between the output side of the DC/DC conversion unit 42 and the load 20.

Herein, the power supply unit PSU0 is operated to supply direct current voltage to the load 20 when the alternating current power supply 10 is sound, and the battery units BBU1 through BBU7 supply direct current voltage to the load 20 when the alternating current power supply 10 fails, or when operation of the power supply unit PSU0 stops due to a failure thereof.

That is, the power supply unit PSU0 corresponds to a main power supply unit in the claims, and the battery units BBU1 through BBU7 correspond to a back-up unit in the claims.

The number of power supply units and battery units not being limited in any way to the example of FIG. 1, an optional number are connected in parallel in accordance with the necessary amount of power supply. Also, there may be one battery unit.

Herein, power line wiring resistance between an output point (a common connection point of all units) 50 of the power supply unit PSU0 and the load 20 is taken to be R₀, and wiring resistances between neighboring output terminals of the power supply unit PSU0 and battery units BBU1 through BBU7 are taken to be R₁ through R₇ respectively.

Assuming at this point that a failure occurs when the power supply unit PSU0 is operating, a case wherein the failure is backed-up by the battery unit BBU7 will be discussed. Herein, a forward voltage drop of the diodes 33 and 43 is ignored, and it is taken that a voltage of the output point 50 is equivalent to a voltage (rated voltage) Vₒᵤₜ required by the load 20 when the power supply unit PSU0 is operating (ignoring the wiring resistance R₀).

The output terminal of the battery unit BBU7 has wiring resistance (R₄+R₅+R₆+R₇) with respect to the output point 50 of FIG. 1. Provisionally, when assuming the voltage Vₒᵤₜ required by the load 20 to be 12V and the wiring resistance (R₄+R₅+R₆+R₇) to be 0.37 mΩ, a voltage drop of 74 mV is caused by the wiring resistance (R₄+R₅+R₆+R₇) when an output current I_{bbu7} of the battery unit BBU7 is 200 A.

Therefore, when the output voltage command value of the battery unit BBU7 is set at 12V, and the current I_{bbu7} is caused to flow at 200 A, the voltage of the output point 50 is of a value 74 mV lower than 12V (actually, a voltage lower still by the amount of the voltage drop caused by the wiring resistance R₀ is applied to the load 20). Although the error voltage 74 mV is a value in the region of 0.6% of 12V, it cannot be said that it is a value that can be ignored with respect to an input voltage error (for example, ±3%) of the load 20 allowable in a steady state.

Therefore, the embodiment is such that, using the following kind of means, a voltage of the same magnitude as that when the power supply unit PSU0 is operating is applied to the load 20 even when a back-up operation is carried out by a battery unit.

Firstly, when backing-up the power supply unit PSU0 using the battery unit BBU7, a calibration operation described below is executed in advance.

That is, the battery unit BBU7 is started up in a state wherein the power supply unit PSU0 is being operated when the alternating current power supply 10 is sound, and an output voltage V_{bbu7} thereof is gradually raised. When the voltage V_{bbu7} exceeds an output voltage Vₚₛᵤ₀ of the power supply unit PSU0 and the current I_{bbu7} flows from the battery unit BBU7, Expression 1 through Expression 3 below are established.

Iₒᵤₜ=Iₚₛᵤ₀+I_{bbu7} [Expression 1]

Vₚₛᵤ₀−Vₒᵤₜ=R₀×Iₒᵤₜ [Expression 3]

V_{bbu7}−Vₚₛᵤ₀=(R₄+R₅+R₆+R₇)×I_{bbu7} [Expression 3]

When taking the output voltage Vₚₛᵤ₀ of the power supply unit PSU0 to be constant, the wiring resistance (R₄+R₅+R₆+R₇) can be calculated from Expression 3 provided that the output voltage V_{bbu7} and output current I_{bbu7} of the battery unit BBU7 during calibration are known. Therefore, when a back-up operation by the battery unit BBU7 is carried out, the output voltage command value of the battery unit BBU7 is calculated by adding I_{bbu7}×(R₄+R₅+R₆+R₇) as a compensation voltage to the voltage Vₒᵤₜ required by the load 20 (equivalent to the voltage of the output point 50 when ignoring the wiring resistance R₀), and the predetermined voltage Vₒᵤₜ can be applied to the load 20 provided that the battery unit BBU7 is operated in accordance with the output voltage command value.

According to Expression 2, the wiring resistance R₀ between the output point 50 and load 20 can be calculated provided that Vₚₛᵤ₀, Vₒᵤₜ, and Iₒᵤₜ are known, and wiring resistance (R₀+R₄+R₅+R₆+R₇) from the load 20 to the output terminal of the battery unit BBU7 can also be calculated.

Consequently, the output voltage command value of the battery unit BBU7 when carrying out a back-up operation may be calculated by calculating I_{bbu7}×(R₀+R₄+R₅+R₆+R₇) as a compensation voltage and adding the compensation voltage to the voltage required by the load 20. By so doing, output voltage compensation of still higher accuracy, including also the wiring resistance R₀, can be carried out.

In the above description, the operation of calibrating the battery unit BBU7 is described, but compensation voltage may also be calculated for another battery unit by calculating the wiring resistance between the relevant battery unit and the output point 50.

Also, when backing-up using a parallel operation of a multiple of battery units, the wiring resistance and compensation voltage can be calculated for each battery unit using basically the same calibration operation as in the case of one battery unit, except for taking into consideration the matter that a total value of the output currents of the multiple of battery units flows through one portion of power line.

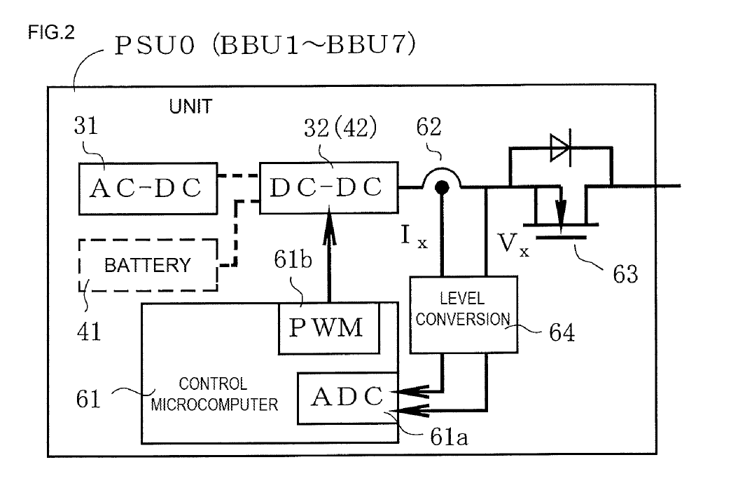

Next, FIG. 2 is a configuration diagram for detecting an output current Iₓ and output voltage Vₓ of the units PSU0 and BBU1 through BBU7, with the configuration being common to all units.

In FIG. 2, a reverse flow prevention element 63 is connected to the output side of the DC/DC conversion unit 32 (42) in the power supply unit PSU0 (or battery units BBU1 to BBU7). The reverse flow prevention element 63 is a semiconductor element such as an OR-ing MOSFET (metal-oxide-semiconductor field effect transistor) with an ultra-low on-state resistance, which prevents reverse flow of current when a multiple of units are operated in parallel, wherein voltage drop when current flows through is of a level that can be ignored.

The output current Iₓ and output voltage Vₓ of the DC/DC conversion unit 32 (42) are input via a level conversion unit 64 into an A/D (analog/digital) conversion unit 61a of a control microcomputer 61, wherein the output current Iₓ and output voltage Vₓ can be calculated by arithmetic processing. 61b is a PWM circuit that generates a pulse width modulation (PWM) signal for driving a semiconductor switching element of the DC/DC conversion unit 32 (42), and 62 is a direct current detector.

By all the units PSU0 and BBU1 through BBU7 including the configuration of FIG. 2, the control microcomputer 61 can detect the output current Iₓ and output voltage Vₓ of the control microcomputer 61 itself. Also, when communicating by specifying the address of a predetermined unit from a master side management microcomputer 80, to be described hereafter, the management microcomputer 80 can monitor the output current Iₓ and output voltage Vₓ of the relevant unit.

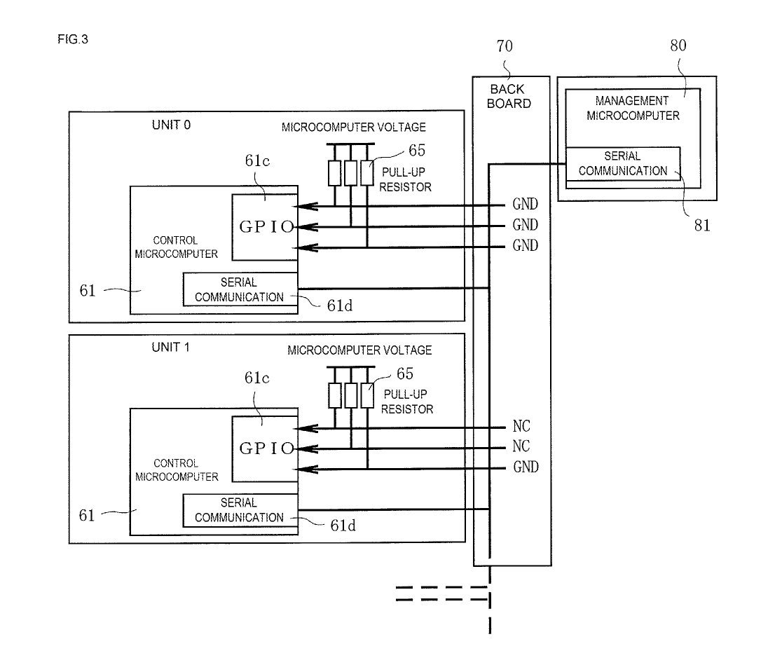

FIG. 3 shows a configuration for specifying the address of each unit (for the sake of convenience, taken to be units 0 and 1) from the master side management microcomputer 80, and monitoring the output current Iₓ and output voltage Vₓ The unit 0 and unit 1 correspond to the power supply unit PSU0 and one of the battery units BBU1 through BBU7.

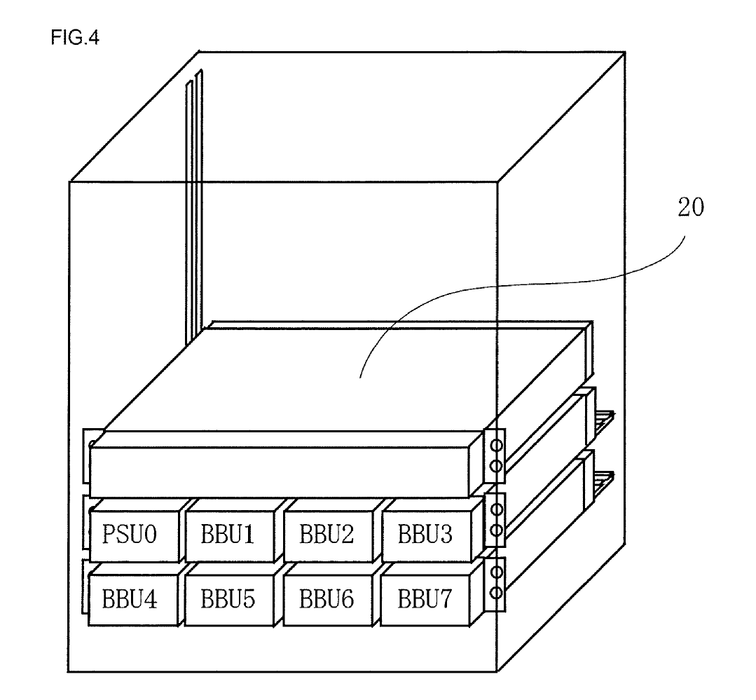

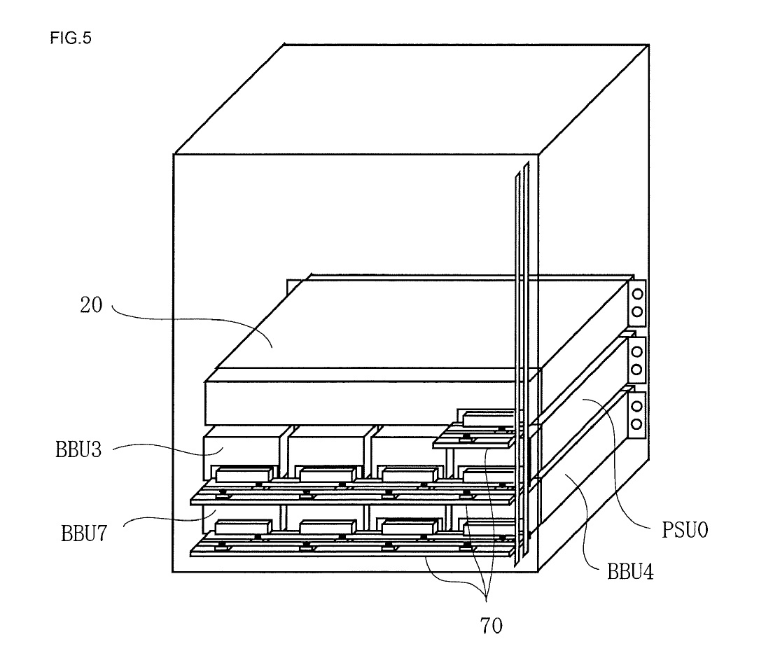

An example of a mounting structure of the units PSU0 and BBU1 through BBU7 and the load 20 is as shown in FIG. 4 and FIG. 5. FIG. 4 is a perspective view of the front side, FIG. 5 is a perspective view of the back side, and a back board 70 to which the direct current output terminals of the units PSU0 and BBU1 through BBU7 are wired OR-connected is disposed on the back side, as shown in FIG. 5.

In FIG. 3, the control microcomputer 61 in, for example, unit 0 includes a general purpose input/output (GPIO) unit 61c and a serial communication unit 61d, and a power supply voltage of the control microcomputer 61 is applied via a pull-up resistor 65 to the general purpose input/output unit 61c. Also, the general purpose input/output unit 61c is connected to a ground terminal GND in the back board 70, or is in a non-connected (NC) state.

Furthermore, the serial communication unit 61d is connected via the back board 70 to a serial communication unit 81 of the management microcomputer 80. The back board 70 is an example of a communication interface for communication between the main power supply unit and the back-up unit. Serial communication unit 81, and general purpose input/output (GPIO) unit 61c and a serial communication unit 61d are also examples of communication interfaces.

This kind of configuration is such that the management microcomputer 80 can recognize the address (the mounting position in FIG. 4 and FIG. 5) of each unit by detecting the connection state of the general purpose input/output unit 61c and back board 70 via the serial communication units 81 and 61d.

For example, as in FIG. 3, the general purpose input/output unit 61c allots the address of the unit 0 connected to “GND, GND, GND” to a 0 compartment, and in the same way, allots the address of the unit 1 (corresponding to one of the battery units BBU1 through BBU7 in FIG. 1) connected to “NC, NC, GND” to a 1 compartment. In this case, as the management microcomputer 80 can recognize that the unit 1 is disposed in the 1 compartment, the management microcomputer 80 can calculate the wiring resistance as far as the output point 50 by monitoring the output current and output voltage of the unit 1 when an operation of calibrating the unit 1 is carried out, and calculate an appropriate output voltage command value for when a back-up operation is carried out by the unit 1.

A method of recognizing the address of each unit not being limited in any way to the heretofore described method, it goes without saying that another method may be used.

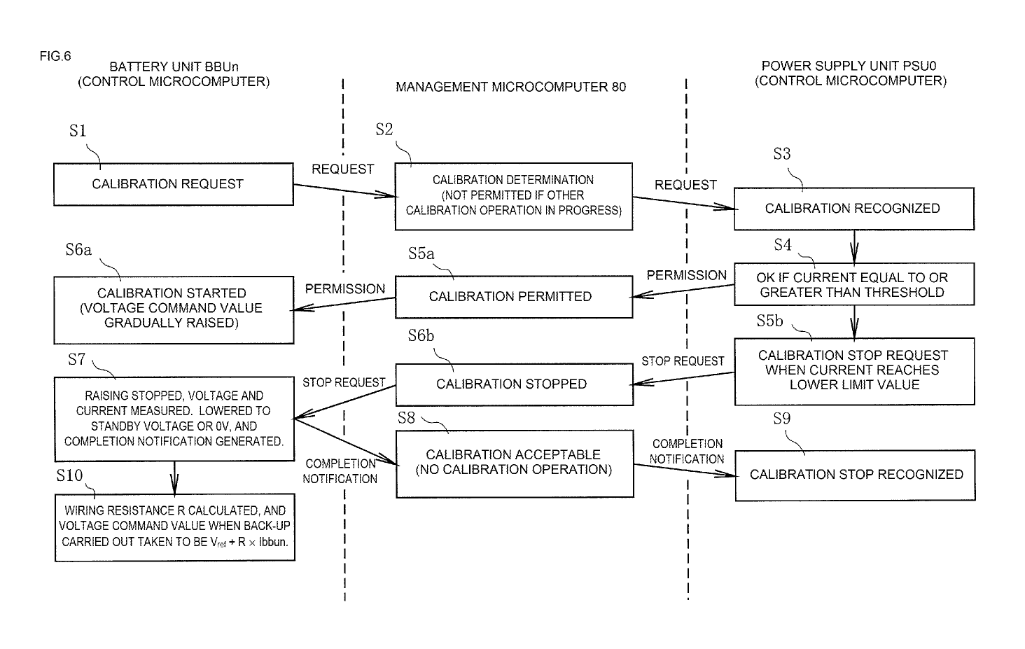

The process of obtaining the compensation voltage by calculating the wiring resistance, and calculating the output voltage command value of the unit 1 by adding the compensation voltage to the voltage V₀ of the output point 50, can also be executed by the control microcomputer 61 in the unit 1, because of which the output voltage command value of the unit 1 may be calculated on the unit 1 side, as shown in FIG. 6.

FIG. 6 is a flowchart showing a process in each unit when there is a calibration request from a certain battery unit BBUn (in the embodiment, n=1 to 7).

Firstly, when the control microcomputer 61 of the battery unit BBUn outputs a calibration request while the power supply unit PSU0 is operating (step S1), the management microcomputer 80, on receiving the calibration request, determines the suitability of the calibration request (S2). Specifically, when another battery unit is carrying out a calibration operation, the calibration request generated this time is not permitted, but when no calibration operation is being carried out, the calibration request is permitted. Herein, which battery unit the calibration request is output from can be identified by the management microcomputer 80 recognizing the previously described address.

Herein, a calibration request may be automatically generated when hot swapping (hot-line mounting) a battery unit.

When the management microcomputer 80 permits a calibration request, the management microcomputer 80 notifies the power supply unit PSU0 that there is a request, and the power supply unit PSU0 recognizes the notification (S3). When the output current Iₚₛᵤ₀ of the power supply unit PSU0 itself reaches zero, the power supply unit PSU0 cannot measure the output voltage Vₚₛᵤ₀, as a result of which there is concern that an excessive voltage will be applied to the load 20. Therefore, the power supply unit PSU0 permits calibration when the output current Iₚₛᵤ₀ is equal to or greater than a threshold, and notifies the management microcomputer 80 (S4).

The management microcomputer 80 receives the notification, and notifies the battery unit BBUn that calibration is permitted (S5a). The battery unit BBUn receives the calibration permission (S5a), starts the calibration operation, and gradually raises the output voltage command value of the battery unit BBUn itself (S6a).

Meanwhile, a calibration stop request is generated in the power supply unit PSU0 when the output current Iₚₛᵤ₀ reaches a lower limit value, and the power supply unit PSU0 notifies the management microcomputer 80 of the stop request (S5b). The calibration stop request (S5b) is received in the management microcomputer 80, and the management microcomputer 80 notifies the battery unit BBUn of the matter (S6b).

The battery unit BBUn receives the calibration stop request (S6b), stops raising the output voltage command value, and measures output voltage V_{bbun} and output current I_{bbun} of the battery unit BBUn itself. Then, the battery unit BBUn lowers the output voltage command value to a predetermined standby voltage or to zero, generates completion notification, and transmits the completion notification to the management microcomputer 80 (S7). Even when there is no calibration stop request from the management microcomputer 80 (S6b), the battery unit BBUn may independently transmit completion notification to the management microcomputer 80 at a point at which output current of a sufficient magnitude is secured.

The management microcomputer 80, on receiving the completion notification, confirms that no calibration operation is being carried out by another battery unit, then creates a state wherein a new calibration request can be received (S8). Also, by the management microcomputer 80 notifying the power supply unit PSU0 that this calibration operation is completed, the power supply unit PSU0 recognizes the stopping of this calibration operation (S9).

The battery unit BBUn that executes the process of step S7 calculates wiring resistance R from the output terminal of the battery unit BBUn to the output point 50 of FIG. 1 using the previously measured output voltage V_{bbun} and output current I_{bbun}, calculates the output voltage command value for when carrying out a back-up operation using V_{ref}+R×I_{bbun}, and stores the output voltage command value in a memory (S10). Herein, V_{ref} is the voltage of the output point 50 required by the load 20, and is equivalent to the rated voltage Vₒᵤₜ of the load 20 when the wiring resistance R₀ of FIG. 1 can be ignored.

By the battery unit BBUn operating in accordance with the output voltage command value stored in the memory when carrying out a back-up operation due to a failure of the alternating current power supply 10, or the like, the battery unit BBUn can apply the voltage Vₒᵤₜ of the same magnitude as when an operation by the power supply unit PSU0 is carried out to the load 20.

The process of the management microcomputer 80 shown in FIG. 6 may be executed by the control microcomputer 61 of the power supply unit PSU0. Also, the process of step S10 in FIG. 6 may be carried out by the management microcomputer 80, the calculated output voltage command value transmitted to the battery unit BBUn, and the battery unit BBUn caused to store the output voltage command value.

According to the embodiment, as heretofore described, when a back-up operation is carried out by the battery unit BBUn, the battery unit BBUn can be operated using an output voltage command value wherein a voltage drop caused by power line wiring resistance is compensated for, whereby the voltage of the output point 50 can be maintained at a value practically the same as when power is supplied by the power supply unit PSU0.

The disclosure can be utilized in a direct current power supply device such that when one of a multiple of direct current power supply units stops operating due to a power failure or breakdown, power continues to be supplied to a load by a back-up operation by another direct current power supply unit. Furthermore, the disclosure is particularly useful when a voltage drop caused by wiring resistance from a direct current power supply unit to a load is of a magnitude than cannot be ignored.

In embodiments according to the present disclosure, functionalities of calculation, control, computing and/or information processing (including those of the control microcomputer 61 and management microcomputer 80) may be implemented in the form of at least one hardware processor configured to perform these functionalities. That is, each of the microcomputers may be at least one hardware processor, and the performance of any one or more of the functionalities may be accomplished by a single hardware processor, or be divided among multiple hardware processors.

Inclusion in this disclosure of any characterization of any product or method of the related art does not imply or admit that such characterization was known in the prior art or that such characterization would have been appreciated by one of ordinary skill in the art at the time a claimed was made, even if the product or method itself was known in the prior art at the time of invention of the present disclosure. For example, if a related art document discussed in the foregoing sections of this disclosure constitutes statutory prior art, the inclusion of any characterization of the related art document does not imply or admit that such characterization of the related art document was known in the prior art or would have been appreciated by one of ordinary skill in the art at the time a claimed invention was made, especially if the characterization is not disclosed in the related art document itself.

While the present disclosure has been particularly shown and described with reference to the embodiments thereof, it will be understood by those skilled in the art that the foregoing and other changes in form and details can be made therein without departing from the spirit and scope of the present disclosure.

Reference signs and numerals are as follows:
PSU0: power supply unit (main power supply unit)
BBU1 through BBU7: battery unit (back-up unit)
10: alternating current power supply
20: load
21: motherboard
31: AC/DC conversion unit
32: DC/DC conversion unit
33: diode
41: battery
42: DC/DC conversion unit
43: diode
50: output point
61: control microcomputer
61a: A/D conversion unit
61b: PWM circuit
61c: general purpose input/output unit
61d: serial communication unit
62: direct current detector
63: reverse flow prevention element
64: level conversion element
65: pull-up resistor
70: back board
80: management microcomputer
81: serial communication unit

What is claimed is:

1. A method for controlling an output voltage of a direct current power supply device including a main power supply unit, which converts alternating current voltage to direct current voltage to supply direct current voltage to a load via an output point, and a back-up unit, which supplies direct current voltage to the load via the output point in a back-up operation that occurs when operation of the main power supply unit is stopped and which is configured to be operated in accordance with an output voltage command value during the back-up operation, the method comprising:
calculating the output voltage command value of the back-up unit by adding a voltage of the output point when the main power supply unit operates and a voltage drop caused by wiring resistance from the back-up unit to the output point, whereby
voltage of the output point when the back-up unit is operated in accordance with the output voltage command value is equivalent to the voltage of the output point when the main power supply unit operates.

2. The method for controlling the output voltage of the direct current power supply device according to claim 1, wherein the calculating the output voltage command value is performed by:
gradually raising output voltage of the back-up unit when the main power supply unit operates,
calculating the wiring resistance from the back-up unit to the output point using output voltage of the main power supply unit and output voltage and output current of the back-up unit, and
calculating the output voltage command value by adding the product of the wiring resistance and output current to the voltage of the output point.

3. The method for controlling the output voltage of the direct current power supply device according to claim 1, further comprising:
storing the calculated output voltage command value in a memory; and
carrying out the back-up operation by using the output voltage command value stored in the memory to operate the back-up unit in accordance with the output voltage command value stored in the memory, such that a voltage of the output point during the back-up operation is equivalent to the voltage of the output point when the main power supply unit operates.

4. A direct current power supply device comprising:
a main power supply unit, which converts alternating current voltage to direct current voltage to supply direct current voltage to a load via an output point, the main power supply unit including at least one processor configured to monitor output voltage and output current of the main power supply unit, and
a back-up unit, which supplies direct current voltage to the load via the output point using a back-up operation when operation of the main power supply unit is stopped and which is configured to be operated in accordance with an output voltage command value during the back-up operation, the back-up unit including at least one processor configured to
detect output voltage and output current of the back-up unit,
calculate wiring resistance from the back-up unit to the output point using output voltage of the main power supply unit when the main power supply unit operates and output voltage and output current of the back-up unit, and
calculate the output voltage command value of the back-up unit by adding the product of the wiring resistance and the output current of the back-up unit to the voltage of the output point.

5. A controller to control an output voltage of a direct current power supply device including a main power supply unit, which converts alternating current voltage to direct current voltage to supply direct current voltage to a load via an output point, a back-up unit, which supplies direct current voltage to the load via the output point using a back-up operation when operation of the main power supply unit is stopped and which is configured to be operated in accordance with an output voltage command value during the back-up operation, and a communication interface implementing communication between the main power supply unit and the back-up unit, wherein each of the main power supply unit and the back-up unit includes at least one processor configured to detect output voltage and output current, the controller comprising:
at least one processor configured to
carry out communication between the main power supply unit and the back-up unit,
calculate wiring resistance from the back-up unit to the output point using output voltage of the main power supply unit when the main power supply unit operates and output voltage and output current of the back-up unit, and
calculate the output voltage command value of the back-up unit in advance by adding the product of the wiring resistance and output current of the back-up unit to the voltage of the output point, and transmits the output voltage command value to the back-up unit.
